(19) United States
(12) Patent Application Publication
(10) Pub. No.: US 2014/0234586 A1
(43) Pub. Date: Aug. 21, 2014

(54) APPARATUS FOR MANUFACTURING HEAT RETAINING MULTI-PLY TEXTILE AND THE HEAT RETAINING MULTI-PLY TEXTILE

(71) Applicants: Tex-Ray Industrial. Co., Ltd., Taipei (TW); Tryd Textile Technologies(Jiangsu) Ltd., Jiangsu (CN); Tryd Textile Research Institute(Jiangsu) Ltd., Jiangsu (CN)

(72) Inventors: CHIEN HUA CHEN, Jiangsu (CN); YU LIANG GU, Jiangsu (CN); CHAO KUEI LEE, Jiangsu (CN); JAI CHENG LIU, Taipei City (TW); JUN DAI, Jiangsu (CN); BEN CHENG LU, Jiangsu (CN); WEI WEI WANG, Jiangsu (CN)

(21) Appl. No.: 13/920,058

(22) Filed: Jun. 17, 2013

(30) Foreign Application Priority Data
Feb. 21, 2013 (CN) 201320078882.4

(51) Int. Cl. B32B 7/14; B32B 5/26; B32B 37/00; A41D 1/02

(52) U.S. Cl. CPC B32B 7/14; A41D 1/02; B32B 5/26; B32B 37/0076
USPC 428/188; 156/548; 156/498; 156/553; 156/383

(57) ABSTRACT

An apparatus for manufacturing a heat retaining multi-ply textile includes an adhesive tank; a lower drive roll partially submerged in the tank; an upper drive roll including spaced, longitudinal projections wherein the projections contact the lower drive roll to bring the adhesive onto the projections; two opposite driven rolls; a first supply spool for moving a continuous upper textile sheet wherein the continuous upper textile sheet moves to have its underside contacted the longitudinal projections when passing the upper drive roll before moves to a joining line of the driven rolls; a second supply spool for moving a continuous lower textile sheet to the joining line of the driven rolls wherein the continuous lower and upper textile sheets are pressed toward each other to form compartments; and an oven for heating in order to produce the production. Down migration can be avoided.

### BACKGROUND OF THE INVENTION

1. Field of the Invention

The invention relates to garment manufacturing and more particularly to an apparatus for manufacturing heat retaining multi-ply textile and the heat retaining multi-ply textile.

2. Description of Related Art

Garments such as down-filled jackets are very popular due to good heat retention capability, softness, light weight, and visually attractiveness. A typical jacket construction is comprised of an outer panel, an inner panel, and down (e.g., duck feathers, goose features, or natural fibers) is filled between the panels as thermal insulator. However, the down may migrate from the specified locations into certain portions, as the lower portions, of the jacket (i.e., down migration) due to no confinement to the down. For solving above problems, the jacket is divided into a plurality of different compartments by stitching in order to confine the down in the compartments. However, a plurality of holes may be formed on and in the jacket due to stitching. Unfortunately, it is possible of migrating the down in an undesirably concentrated manner into certain portions of the jacket through the holes. The migrated down can render the jacket visually unattractive.

Thus, the need for improvement still exists.

### SUMMARY OF THE INVENTION

It is therefore one object of the invention to provide an apparatus for manufacturing a heat retaining multi-ply textile comprising a tank filled with adhesive; a lower drive roll partially submerged in the adhesive; an upper drive roll including a plurality of spaced, longitudinal projections on a cylindrical, outer surface wherein rotating directions of the upper and lower drive rolls are opposite, and wherein the upper and lower drive rolls are opposite with the longitudinal projections contacting an outer surface of the lower drive roll so as to bring the adhesive onto the projections; a pair of opposite driven rolls disposed downstream of the upper drive roll; a first supply spool for steadily moving a continuous upper textile sheet forward wherein the continuous upper textile sheet moves to have its underside contacted the longitudinal projections when passing the upper drive roll before moves to a joining line of the driven rolls; a second supply spool for steadily moving a continuous lower textile sheet to the joining line of the driven rolls wherein the continuous lower textile sheet and the continuous upper textile sheet are pressed toward each other by the driven rolls to cause the adhesive to adhere the continuous lower textile sheet and the continuous upper textile sheet together to form a half finished heat retaining multi-ply textile including a plurality of compartments; and an oven disposed downstream of the driven rolls for heating the forward moving half finished heat retaining multi-ply textile to a predetermined temperature so as to cure the adhesive and produce a finished heat retaining multi-ply textile after cooling; wherein each of the compartments is defined by the upper textile sheet, the lower textile sheet, two open sides of the finished heat retaining multi-ply textile, and two adjacent transverse sealing members formed of the cured adhesive.

Preferably, further comprises a thermal insulator filled in at least one of the compartments.

Preferably, the adhesive is acrylic resin, polyurethane resin, or polytetrafluoroethene resin.

Preferably, the longitudinal projections are equally spaced, parallel longitudinal projections; equally spaced, longitudinal curved projections; equally spaced, longitudinal projections having a plurality of connected garble sections; longitudinal curved projections; or equally spaced, concentric arc-shaped projections.

Preferably, the thermal insulator is gas, duck feathers, goose features, or natural fibers.

Preferably, the compartments are disposed horizontally or inclined on a garment when the garment is made of the finished heat retaining multi-ply textile.

It is a second object of the invention to provide an apparatus for manufacturing a heat retaining multi-ply textile comprising a pair of opposite drive rolls being intermittently rotated in opposite directions; a first supply spool disposed upstream of the drive rolls for intermittently moving a continuous upper textile sheet toward a joining line of the drive rolls; a second supply spool disposed upstream of the drive rolls for intermittently moving a continuous lower textile sheet toward the joining line of the drive rolls so that the continuous upper textile sheet and the continuous lower textile sheet can be pressed together to form a half finished heat retaining multi-ply textile; a sealing device disposed downstream of the drive rolls and being intermittently activated to press onto the passing half finished heat retaining multi-ply textile to form a plurality of equally spaced, transverse welding lines thereon and a plurality of compartments therein; and a pair of opposite driven rolls disposed downstream of the sealing device for further pressing the passing half finished heat retaining multi-ply textile to produce a finished heat retaining multi-ply textile after cooling; wherein each of the compartments is defined by the upper textile sheet, the lower textile sheet, two open sides of the finished heat retaining multi-ply textile, and two adjacent transverse welding lines.

Preferably, further comprises a thermal insulator filled in at least one of the compartments.

Preferably, the sealing device is an intermittently activated high frequency welding device, an intermittently activated heating device, or an intermittently activated ultrasonic welding device.

Preferably, the sealing device is comprised of an intermittently activated high frequency welding device having a positive electrode, and a negative electrode disposed below the positive electrode; and wherein both the positive electrode and the negative electrode are shaped as equally spaced, parallel longitudinal projections; equally spaced, longitudinal curved projections; equally spaced, longitudinal projections having a plurality of connected garble sections; longitudinal curved projections; or equally spaced, concentric arc-shaped projections.

Preferably, the thermal insulator is gas, duck feathers, goose features, or natural fibers.

It is a third object of the invention to provide a heat retaining multi-ply textile, comprising an upper textile sheet; a lower textile sheet; and a plurality of transverse sealing members fastened between the upper textile sheet and the lower textile sheet for forming a plurality of compartments therebetween; wherein each of the compartments has two open sides for allowing a thermal insulator filled therein.

Preferably, the sealing members are equally spaced, parallel projections; equally spaced curved projections; equally spaced projections having a plurality of connected garble sections; curved projections; or equally spaced, concentric arc-shaped projections.

Preferably, the compartments are disposed horizontally or inclined on a garment when the garment is made of the finished heat retaining multi-ply textile.

The above and other objects, features and advantages of the invention will become apparent from the following detailed description taken with the accompanying drawings.

### BRIEF DESCRIPTION OF THE DRAWINGS

FIG. 1 schematically depicts an apparatus for manufacturing heat retaining multi-ply textile according to a first preferred embodiment of the invention;

FIGS. 2A, 2B, 2C, 2D and 2E are perspective views of five different configurations of projections of the upper drive roll;

FIG. 3 is a top plan view of the finished multi-ply textile without down filling;

FIG. 3A is a detailed view of the area in circle A of FIG. 3;

FIG. 4 is a longitudinal sectional view of the finished multi-ply textile of FIG. 3;

FIG. 5 is an enlarged view of a portion of compartment with down filling;

FIG. 5A is a sectional view taken along lines A-A of FIG. 5;

FIG. 6 schematically depicts an apparatus for manufacturing heat retaining multi-ply textile according to a second preferred embodiment of the invention; and

FIG. 7 is a front view of a garment comprising a plurality of the multi-ply textiles having a plurality of the compartments manufactured according to the invention.

### DETAILED DESCRIPTION OF THE INVENTION

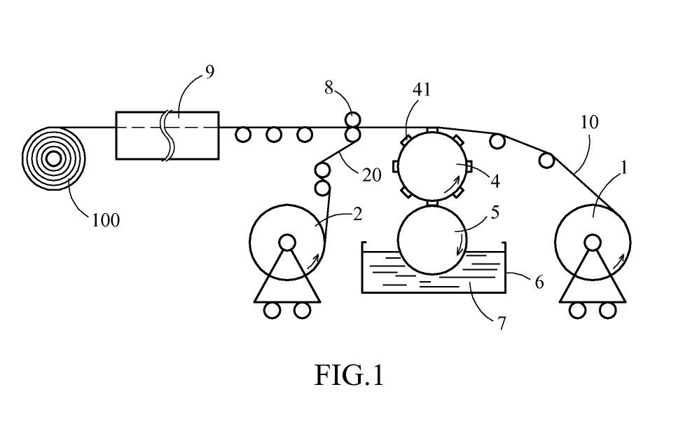

Referring to FIGS. 1 to 5A, an apparatus for manufacturing heat retaining multi-ply textile and the heat retaining multi-ply textile in accordance with a first preferred embodiment of the invention comprises the following components as discussed in detail below.

An endless, continuous upper textile sheet 10 is supplied out of a first supply spool 1. An endless, continuous lower textile sheet 20 is supplied out of a second supply spool 2. A tank 6 is filled with adhesive 7. A lower drive roll 5 is partially submerged in the adhesive 7. An upper drive roll 4 has a plurality of equally spaced, parallel longitudinal projections 41 on a cylindrical, outer surface. The projection 41 has a rectangular cross-section. The upper and lower drive rolls 4, 5 are opposite with the projections 41 contacting an outer surface of the lower drive roll 5. Rotating directions of the upper and lower drive rolls 4, 5 are opposite. Thus, the adhesive 7 can be brought upward to the projections 41 and in turn the adhesive 7 is intermittently brought upward across an underside of the endless, continuous upper textile sheet 10 when both the lower and lower drive rolls, 4 5 rotate. The endless, continuous upper textile sheet 10 is moved to a joining line of a pair of opposite driven rolls 8. At the same time, the endless, continuous lower textile sheet 20 is brought upward to the joining line of the pair of opposite driven rolls 8 to press onto and adhered to the underside of the endless, continuous upper textile sheet 10 by the adhesive 7 and by the pair of opposite driven rolls 8. A half finished heat retaining multi-ply textile having a plurality of compartments 30 is obtained in which each compartment 30 is defined by the upper textile sheet 10, the lower textile sheet 20, two open sides, and two adjacent transverse sealing members 3 formed of the adhesive 7. The half finished multi-ply textile is sent through an oven 9 to heat at a temperature in a range of 80° C. to 140° C. to cure the transverse sealing members 3 in order to fasten the upper and lower textiles 10, 20 of the half finished multi-ply textile together. Finally, a finished multi-ply textile 100 having a plurality of compartments 30 is cooled in room temperature and wrapped on a take-up spool.

Preferably, the adhesive 7 is acrylic resin, polyurethane resin, or polytetrafluoroethene resin.

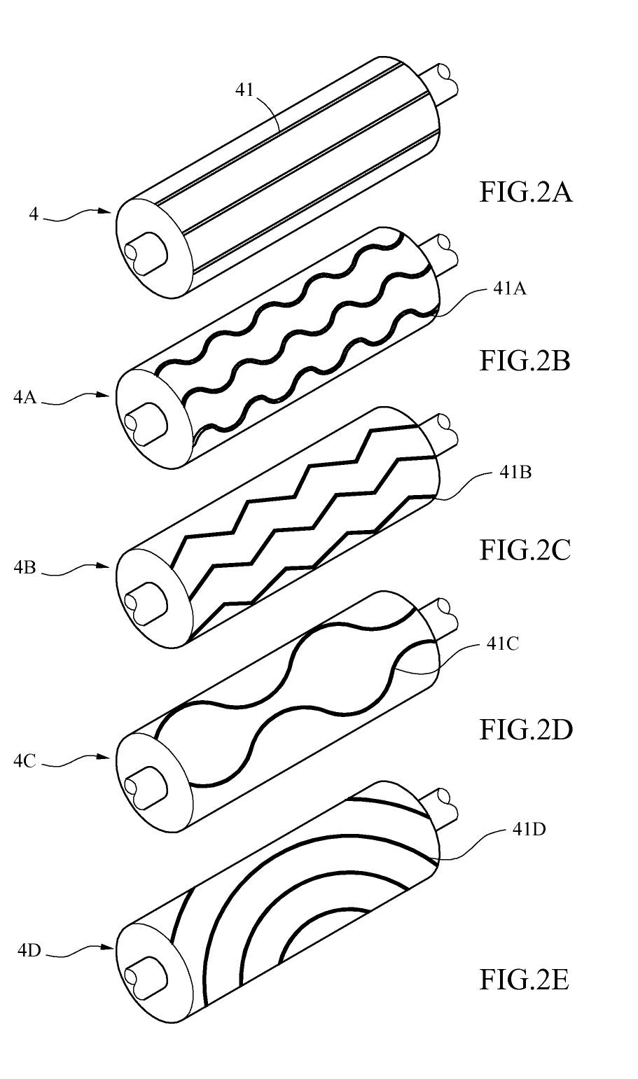

The equally spaced, parallel longitudinal projections 41 are shown in FIG. 2A.

Alternatively, the equally spaced, parallel longitudinal projections are replaced with a plurality of equally spaced, longitudinal curved projections 41A on a cylindrical, outer surface of an upper drive roll 4A as shown in FIG. 2B.

Alternatively, the equally spaced, parallel longitudinal projections are replaced with a plurality of equally spaced, longitudinal projections 41B having a plurality of connected garble sections on a cylindrical, outer surface of an upper drive roll 4B as shown in FIG. 2C.

Alternatively, the equally spaced, parallel longitudinal projections are replaced with a plurality of longitudinal curved projections 41C on a cylindrical, outer surface of an upper drive roll 4C as shown in FIG. 2D.

Alternatively, the equally spaced, parallel longitudinal projections are replaced with a plurality of equally spaced, concentric arc-shaped projections 41D on a cylindrical, outer surface of an upper drive roll 4D as shown in FIG. 2E.

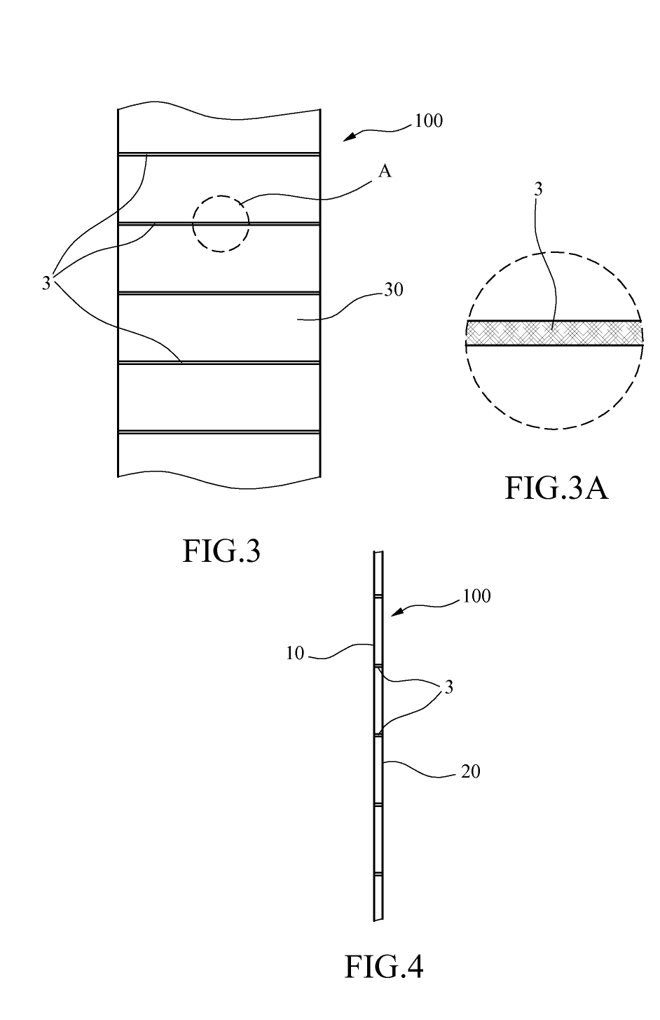

As shown in FIGS. 3, 3A and 4 specifically, the compartment 30 is defined by the upper textile sheet 10, the lower textile sheet 20, two open sides, and two adjacent transverse sealing members 3 formed of the adhesive 7.

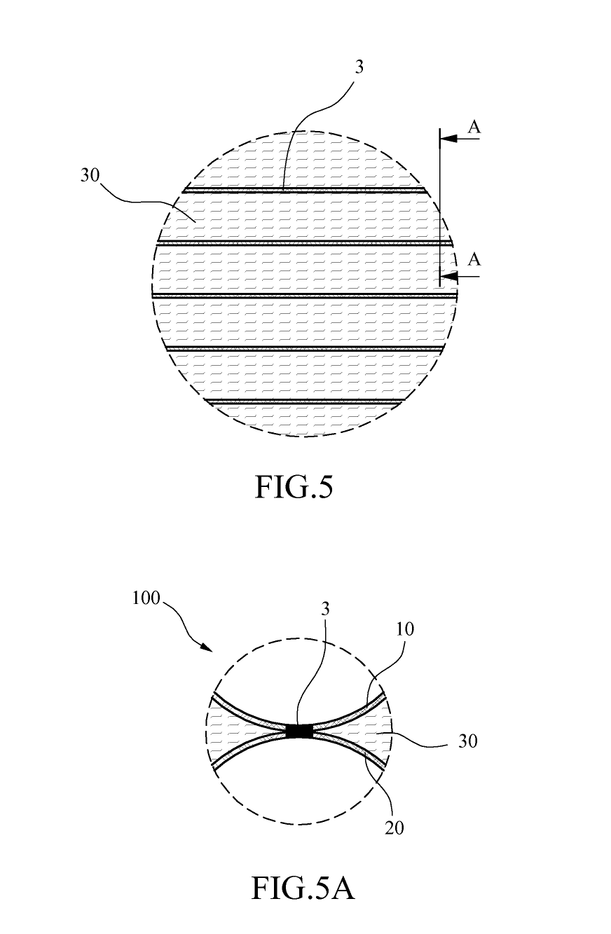

As shown in FIGS. 5 and 5A specifically, gas (e.g., air or ammonia) can be filled in the compartments 30 as thermal insulator. Alternatively, down (e.g., duck feathers, goose features, or natural fibers) can be filled in the compartments 30 as thermal insulator. It is envisaged by the invention that the down is confined in the compartment 30 and prevented from migrating to other portions of the multi-ply textile 100 because the transverse sealing members 3 are fixed in position due to the nature of adhesive rather than conventional stitching.

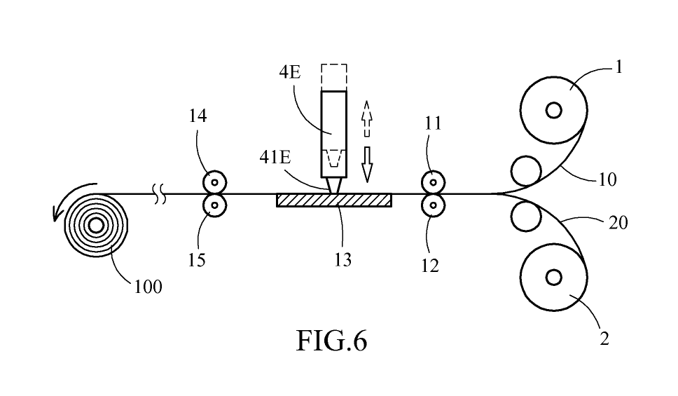

Referring to FIG. 6, an apparatus for manufacturing heat retaining multi-ply textile in accordance with a second preferred embodiment of the invention is shown. The characteristics of the second preferred embodiment are substantially the same as that of the first preferred embodiment except the following:

An endless, continuous upper textile sheet 10 is supplied out of a first supply spool 1. An endless, continuous lower textile sheet 20 is supplied out of a second supply spool 2. An upper drive roll 11 and a lower drive roll 12 are disposed oppositely and are in close proximity. Rotating directions of the upper and lower drive rolls 4, 5 are opposite. The endless, continuous upper textile sheet 10 and the endless, continuous lower textile sheet 20 are intermittently moved to a joining line of the opposite drive rolls 11, 12 by the upper and lower drive rolls 4, 5. Thus, the endless, continuous upper textile sheet 10 and the endless, continuous lower textile sheet 20 are pressed toward each other to form a half finished heat retaining multi-ply textile. The heat retaining multi-ply textile is in turn brought onto a top of a negative electrode 13. A positive electrode 41E of a high frequency welding device 4E is driven downward to be in close proximity with the negative electrode 13 in an intermittent manner. This high frequency field causes the molecules in the half finished heat retaining multi-ply textile to move and get hot, and the combination of this heat under pressure causes the weld to take place. As such, the half finished heat retaining multi-ply textile having a plurality of compartments is secured. Further, the half finished heat retaining multi-ply textile is brought to a joining line of a pair of opposite driven rolls 14, 15 in order to be further pressed. As a result, a finished multi-ply textile 100 is cooled at room temperature and wrapped on a take-up spool. The compartment is defined by the upper textile sheet 10, the lower textile sheet 20, two open sides, and two adjacent transverse welding lines. The half finished multi-ply textile is sent through an oven 9 to heat at a temperature in a range of 80° C. to 140° C. prior to being cooled in room temperature and wrapped on a take-up spool.

Preferably, both the positive electrode 41E and the negative electrode 13 are shaped as equally spaced, parallel longitudinal projections; equally spaced, longitudinal curved projections; equally spaced, longitudinal projections having a plurality of connected garble sections; longitudinal curved projections; or equally spaced, concentric arc-shaped projections.

Activation period of time of the high frequency welding device 4E depends on properties and thicknesses of the endless, continuous upper textile sheet 10 and the endless, continuous lower textile sheet 20. Similarly, the high frequency welding device 43 and the negative electrode 13 can be replaced with an intermittently activated heating device or an intermittently activated ultrasonic welding device in other alternative embodiments.

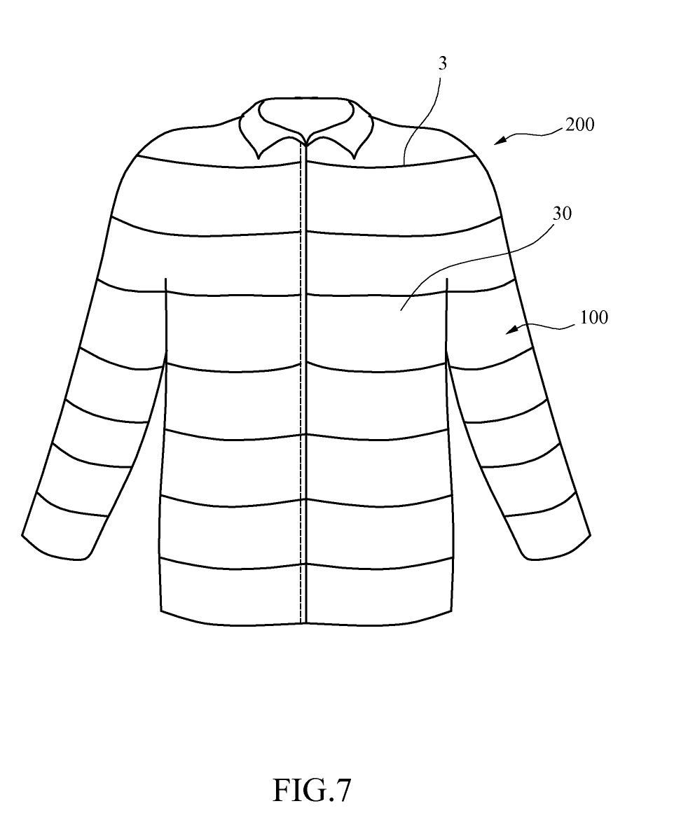

Referring to FIG. 7, a garment 200 having a plurality of multi-ply textiles 100 of different sizes is shown. The compartments 30 are disposed horizontally or inclined. It is also shown that any two adjacent compartments 30 are separated by a transverse sealing member 3. The garment 200 is good in retaining heat.

While the invention has been described in terms of preferred embodiments, those skilled in the art will recognize that the invention can be practiced with modifications within the spirit and scope of the appended claims.

What is claimed is:

1. An apparatus for manufacturing a heat retaining multi-ply textile comprising:
a tank filled with adhesive;
a lower drive roll partially submerged in the adhesive;
an upper drive roll including a plurality of spaced, longitudinal projections on a cylindrical, outer surface wherein rotating directions of the upper and lower drive rolls are opposite, and wherein the upper and lower drive rolls are opposite with the longitudinal projections contacting an outer surface of the lower drive roll so as to bring the adhesive onto the projections;
a pair of opposite driven rolls disposed downstream of the upper drive roll;
a first supply spool for steadily moving a continuous upper textile sheet forward wherein the continuous upper textile sheet moves to have its underside contacted the longitudinal projections when passing the upper drive roll before moves to a joining line of the driven rolls; and
a second supply spool for steadily moving a continuous lower textile sheet to the joining line of the driven rolls wherein the continuous lower textile sheet and the continuous upper textile sheet are pressed toward each other by the driven rolls to cause the adhesive to adhere the continuous lower textile sheet and the continuous upper textile sheet together to form a half finished heat retaining multi-ply textile including a plurality of compartments:
wherein each of the compartments is defined by the upper textile sheet, the lower textile sheet, two open sides of the finished heat retaining multi-ply textile, and two adjacent transverse sealing members formed of the cured adhesive.

2. The apparatus of claim 1, further comprising an oven disposed downstream of the driven rolls for heating the forward moving half finished heat retaining multi-ply textile to a predetermined temperature so as to cure the adhesive and produce a finished heat retaining multi-ply textile after cooling.

3. The apparatus of claim 1, further comprising a thermal insulator filled in at least one of the compartments.

4. The apparatus of claim 1, wherein the adhesive is acrylic resin, polyurethane resin, or polytetrafluoroethene resin.

5. The apparatus of claim 1, wherein the longitudinal projections are equally spaced, parallel longitudinal projections; equally spaced, longitudinal curved projections; equally spaced, longitudinal projections having a plurality of connected garble sections; longitudinal curved projections; or equally spaced, concentric arc-shaped projections.

6. The apparatus of claim 3, wherein the thermal insulator is gas, duck feathers, goose features, or natural fibers.

7. The apparatus of claim 1, wherein the compartments are disposed horizontally or inclined on a garment when the garment is made of the finished heat retaining multi-ply textile.

8. An apparatus for manufacturing a heat retaining multi-ply textile comprising:
a pair of opposite drive rolls being intermittently rotated in opposite directions;
a first supply spool disposed upstream of the drive rolls for intermittently moving a continuous upper textile sheet toward a joining line of the drive rolls;
a second supply spool disposed upstream of the drive rolls for intermittently moving a continuous lower textile sheet toward the joining line of the drive rolls so that the continuous upper textile sheet and the continuous lower textile sheet can be pressed together to form a half finished heat retaining multi-ply textile;
a sealing device disposed downstream of the drive rolls and being intermittently activated to press onto the passing half finished heat retaining multi-ply textile to form a plurality of equally spaced, transverse welding lines thereon and a plurality of compartments therein; and
a pair of opposite driven rolls disposed downstream of the sealing device for further pressing the passing half finished heat retaining multi-ply textile to produce a finished heat retaining multi-ply textile after cooling;
wherein each of the compartments is defined by the upper textile sheet, the lower textile sheet, two open sides of the finished heat retaining multi-ply textile, and two adjacent transverse welding lines.

9. The apparatus of claim 8, further comprising a thermal insulator filled in at least one of the compartments.

10. The apparatus of claim 8, wherein the sealing device is an intermittently activated high frequency welding device, an intermittently activated heating device, or an intermittently activated ultrasonic welding device.

11. The apparatus of claim 8, wherein the sealing device is comprised of an intermittently activated high frequency welding device having a positive electrode, and a negative electrode disposed below the positive electrode; and wherein both the positive electrode and the negative electrode are shaped as equally spaced, parallel longitudinal projections; equally spaced, longitudinal curved projections; equally spaced, longitudinal projections having a plurality of connected garble sections; longitudinal curved projections; or equally spaced, concentric arc-shaped projections.

12. The apparatus of claim 8, wherein the thermal insulator is gas, duck feathers, goose features, or natural fibers.

13. A heat retaining multi-ply textile, comprising:
an upper textile sheet;
a lower textile sheet; and
a plurality of transverse sealing members fastened between the upper textile sheet and the lower textile sheet for forming a plurality of compartments therebetween;
wherein each of the compartments has two open sides for allowing a thermal insulator filled therein.

14. The heat retaining multi-ply textile of claim 13, wherein the sealing members are equally spaced, parallel projections; equally spaced curved projections; equally spaced projections having a plurality of connected garble sections; curved projections; or equally spaced, concentric arc-shaped projections.

15. The heat retaining multi-ply textile of claim 13, wherein the compartments are disposed horizontally or inclined on a garment when the garment is made of the finished heat retaining multi-ply textile.

16. The heat retaining multi-ply textile of claim 13, wherein the thermal insulator is gas, duck feathers, goose features, or natural fibers.
